(19) United States
(12) Patent Application Publication
(10) Pub. No.: US 2025/0029472 A1
(43) Pub. Date: Jan. 23, 2025

(54) BEHAVIOR MONITORING SYSTEM AND POWER SAVING METHOD THEREOF

(71) Applicant: FUJI CORPORATION, Chiryu (JP)

(72) Inventor: Koji KAWAGUCHI, Kasugai-shi (JP)

(73) Assignee: FUJI CORPORATION, Chiryu (JP)

(21) Appl. No.: 18/684,421

(22) PCT Filed: Sep. 7, 2021
(86) PCT No.: PCT/JP2021/032878

§ 371 Date: Feb. 16, 2024

(51) Int. Cl. G08B 21/22; G05B 15/02

(52) U.S. Cl. CPC G08B 21/22; G05B 15/02

(57) ABSTRACT

A behavior monitoring system includes a detection section, a determination section, and a power control section. The detection section includes an opening/closing detection sensor corresponding to opening and closing of a door of any room of a residence, and a human detection sensor provided in each room and configured to detect presence/absence of a human. The determination section determines, based on detection of opening and closing of a door of any room of the residence by a corresponding opening/closing detection sensor and detection of a human by a human detection sensor provided in the room, that a monitoring target person is present in the room. The power control section switches, in a case where a room in which the monitoring target person is present is determined, a mode of a detection section provided in a room other than the room in which the monitoring target person is present from a normal mode to a power saving mode.

### TECHNICAL FIELD

The present description discloses a behavior monitoring system and a power saving method thereof.

### BACKGROUND ART

Conventionally, as this type of behavior monitoring system, there has been proposed a system in which a monitored subject monitoring apparatus is provided in each of multiple rooms allocated as a living space of a monitored subject (for example, refer to Patent Literature 1). All the monitored subject monitoring apparatuses are communicably connected to each other via a network, and each monitored subject monitoring apparatus includes a communication IF section, an imaging section (camera), a presence determination section configured to determine presence/absence of a monitored subject in an imaging target based on an image in the imaging target generated by the imaging section, and an operation mode control section (control processing section) configured to control an operation mode. When it is determined that the monitored subject is present in the imaging target in the monitored subject monitoring apparatus, the operation mode control section of each monitored subject monitoring apparatus controls the communication IF section, the imaging section, and the like in a normal operation mode in which the communication IF section, the imaging section, and the like is in an active state, and performs, with the communication IF section, broadcast communication of a command for other monitored subject monitoring apparatuses to shift to a power saving operation mode in which the communication IF section is in an active state while each of the imaging section and the presence determination section is caused to sleep.

### Patent Literature

Patent Literature 1: JP-A-2016-173642

### BRIEF SUMMARY

### Technical Problem

In the above-described behavior monitoring system, since it is determined whether a monitored subject is present in an imaging target by imaging an inside of the imaging target with a camera, a camera is required in each room, which causes an increase in cost. Furthermore, the monitored subject may feel uncomfortable for being monitored by the camera at all times.

A main object of the present disclosure is to enable power saving at low cost in a behavior monitoring system configured to monitor a behavior of a monitoring target person who lives in a residence.

### Solution to Problem

The present disclosure employs the following means in order to achieve the main object described above.

The gist of a behavior monitoring system according to the present disclosure is to be
a behavior monitoring system for monitoring a behavior of a monitoring target person who lives in a residence, and to include
a detection section including an opening/closing detection sensor provided on a door partitioning each room of the residence and configured to detect opening and closing of a corresponding door, and a human detection sensor provided in each room and configured to detect presence/absence of a human,
a determination section configured to determine, based on detection of opening and closing of a door of any room of the residence by the corresponding opening/closing detection sensor and detection of a human by the human detection sensor provided in the room, that the monitoring target person is present in the room, and
a power control section configured to switch, in a case where the determination section determines a room in which the monitoring target person is present, a mode of the detection section provided in a room other than the room in which the monitoring target person is present from a normal mode to a power saving mode.

In the behavior monitoring system of the present disclosure, it is determined, based on the detection of the opening and closing of the door of any room of the residence by the corresponding opening/closing detection sensor and detection of the human by the human detection sensor provided in the room, that the monitoring target person is present in the room. Accordingly, it is possible to more reliably specify the room in which the monitoring target person is present without using an expensive sensor as the human detection sensor. Furthermore, when the room in which the monitoring target person is present is determined, a mode of a detection section (the opening/closing detection sensor and the human detection sensor) provided in a room other than the room in which the monitoring target person is present is switched from a normal mode to a power saving mode. Accordingly, it is possible to suppress power consumption to an unnecessary sensor or the like. As a result, it is possible to provide a behavior monitoring system capable of saving power at low cost.

### BRIEF DESCRIPTION OF DRAWINGS

FIG. 1 is a schematic configuration diagram of a behavior monitoring system according to the present embodiment.

FIG. 2 is a diagram illustrating an example of a sensor installed in each room of a residence.

FIG. 3 is a flowchart illustrating an example of data measurement processing.

FIG. 4 is a flowchart illustrating an example of the data measurement processing.

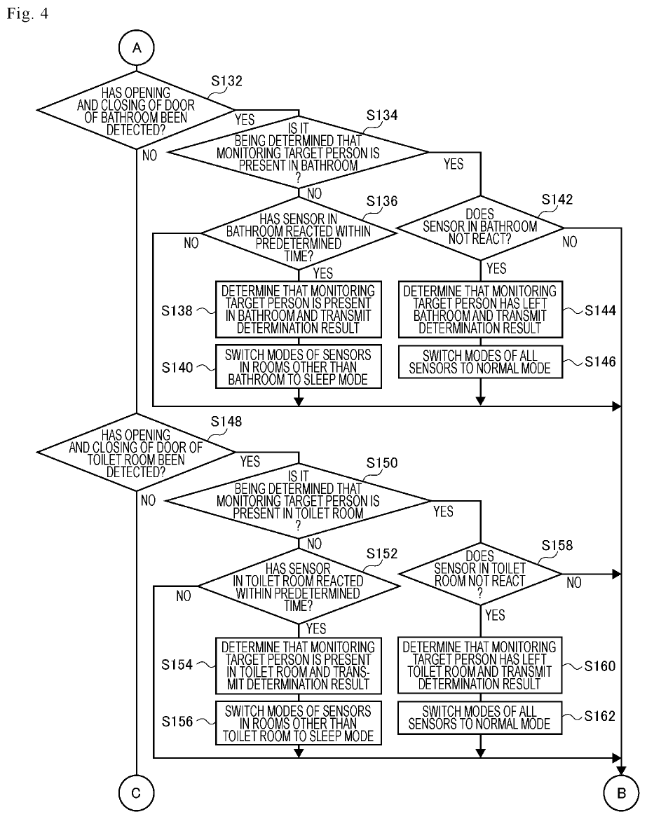

FIG. 5 is a flowchart illustrating an example of the data measurement processing.

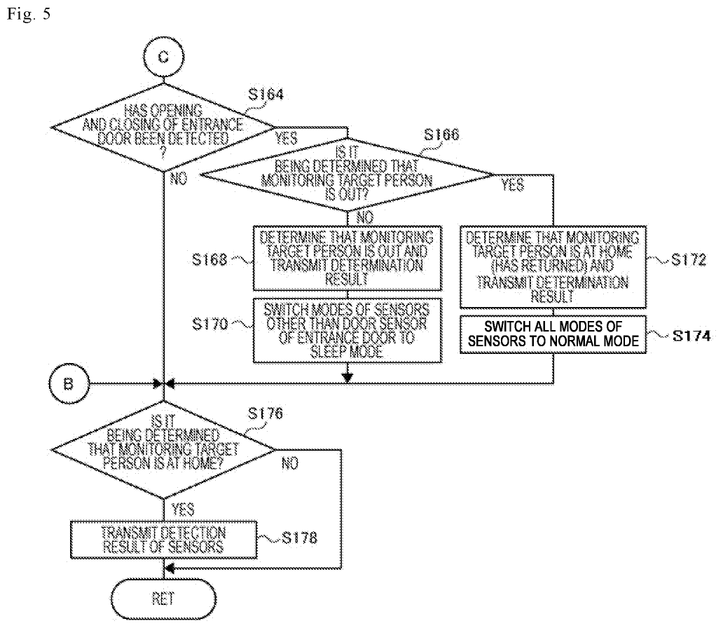

FIG. 6 is a flowchart illustrating an example of behavior pattern determination processing.

FIG. 7 is a diagram illustrating an example of an installation position of a camera.

FIG. 8 is a diagram illustrating an example of an imaging result of the camera.

### DESCRIPTION OF EMBODIMENTS

Next, an embodiment of the present disclosure will be described with reference to the drawings.

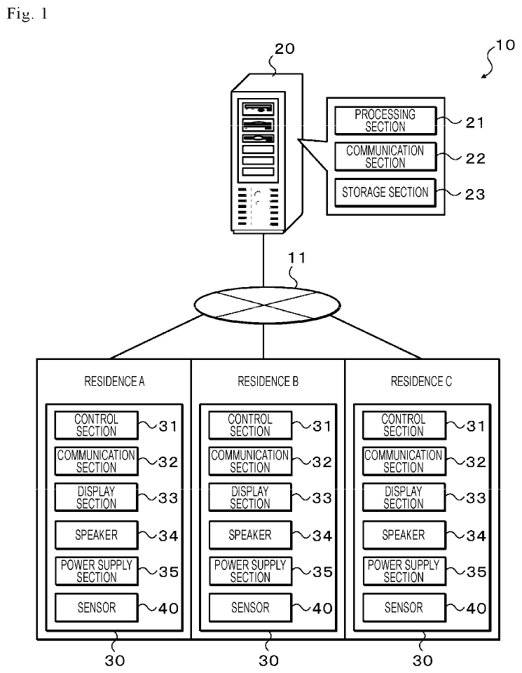

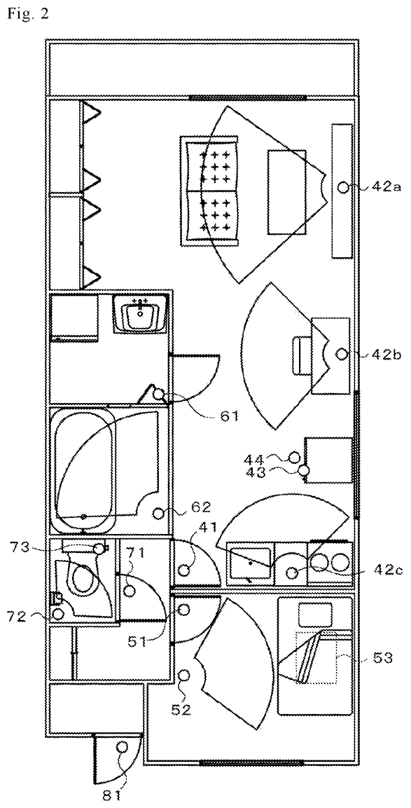

FIG. 1 is a schematic configuration diagram of behavior monitoring system 10 of the present embodiment. As illustrated in FIG. 1, behavior monitoring system 10 of the present embodiment includes management server 20 that manages the entire system, and monitoring apparatuses 30 respectively installed in residences A to C in which a monitoring target person lives. Residences A to C are residences in which, for example, an elderly person or a person requiring care lives alone, and include, for example, an L (living) D (dining) K (kitchen) room, a bedroom, a washroom, a bathroom, a toilet room, and an entrance as illustrated in FIG. 2. Behavior monitoring system 10 can be used, for example, to monitor a behavior of an elderly person or a person requiring care as the monitoring target person in place of a caregiver and to find out an abnormality in the behavior at an early stage.

Monitoring apparatus 30 includes control section 31, communication section 32, display section 33, speaker 34, power supply section 35 (power supply circuit), and sensors 40. Control section 31 is configured as a microprocessor including CPU as a main component, and includes ROM, RAM, and the like in addition to the CPU. Display section 33 and speaker 34 output various information from management server 20 through display or audio.

Sensors 40 are sensors for detecting where the monitoring target person who lives in the residence is and what the monitoring target person who lives in the residence does, and include, as illustrated in FIG. 2, door sensors 41, 43, 51, 61, 71, and 81, human sensors 42a, 42b, 42c, 52, 62, and 72, sleep sensor 53, toilet faucet sensor 73, and temperature sensor 44.

Door sensors 41, 43, 51, 61, 71, and 81 are, for example, magnet-type opening/closing sensors including permanent magnets fixed to door sides and magnetic sensors fixed to frame sides. Door sensor 41 is provided on a door of the LDK room, door sensor 43 is provided on a door of a refrigerator installed in the kitchen, and door sensor 51 is provided on a door of the bedroom. Door sensor 61 is provided on a door of the bathroom, door sensor 71 is provided on a door of the toilet room, and door sensor 81 is provided on an entrance door.

Human sensors 42a, 42b, 42c, 52, 62, and 72 are sensors that detect a person in a detection area in a non-contact manner, and are configured as. for example, infrared sensors that sense an infrared ray and convert the infrared ray into an electric signal. Human sensors 42a, 42b, and 42c are provided in the living section, dining section, and kitchen of the LDK room, respectively. Human sensor 52 is provided in the bedroom, human sensor 62 is provided in the bathroom, and human sensor 72 is provided in the toilet room.

Sleep sensor 53 is, for example, a sheet-type biometric sensor provided under a bed mattress in the bedroom, and acquires biometric information such as a pulse and respiration of a person lying on the bed. Temperature sensor 44 is provided on a front side of the refrigerator, and detects a change in an ambient temperature when the door of the refrigerator is opened. Toilet faucet sensor 73 detects an operation of a flush lever or a flush switch of a toilet bowl, and in the present embodiment, the sensor detects a large-flush operation and a small-flush operation in an identifiable manner.

Power supply section 35 is a power supply circuit that is connected to a commercial power system, converts alternating current power from the commercial power system into direct current power of a predetermined voltage, and supplies the direct current power to control section 31, communication section 32, display section 33, speaker 34, and sensors 40. Power supply section 35 is capable of individually controlling power supply for each sensor of sensors 40, and has, as power supply modes, a normal mode in which power is supplied to a sensor and the sensor is in an operable state, and a sleep mode (power saving mode) in which power supply to the sensor is stopped and the sensor is in an inoperable sleep state. Each sensor of sensors 40 is switched between the normal mode and the sleep mode with power supply section 35 controlled by control section 31.

Management server 20 includes processing section 21, communication section 22, and storage section 23. Processing section 21 is configured as a microprocessor including CPU as a main component, and includes ROM, RAM, and the like in addition to the CPU. Communication section 22 of management server 20) is connected to communication section 32 of each monitoring apparatus 30 via network 11 such as the Internet, and management server 20 and each monitoring apparatus 30 exchange data and a signal with each other via communication sections 22 and 32. Storage section 23 is configured with an HDD, an SSD, or the like, receives data measured by each monitoring apparatus 30, and stores the data for a certain period of time.

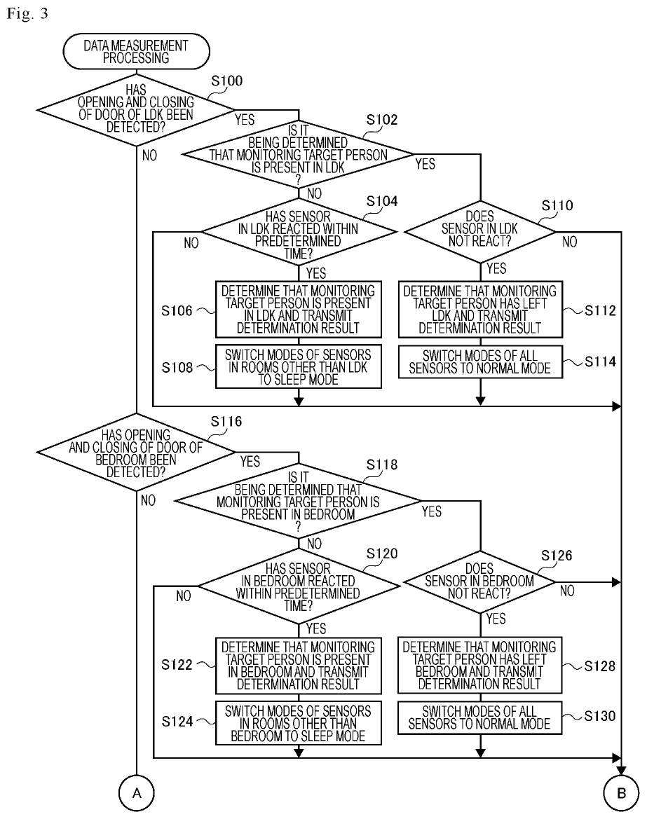

Next, an operation of a behavior monitoring system configured as described above will be described. First, an operation of monitoring apparatus 30 will be described, and then an operation of management server 20 will be described. FIG. 3 is a flowchart illustrating an example of a data measurement processing executed by control section 31 of monitoring apparatus 30 installed in each of residences A to C. This processing is repeatedly executed at a predetermined time interval.

In the data measurement processing, control section 31 determines whether door sensor 41 has detected opening and closing of the door of the LDK room (step S100), whether door sensor 51 has detected opening and closing of the door of the bedroom (step S116), whether door sensor 61 has detected opening and closing of the door of the bathroom (step S132), whether door sensor 71 has detected opening and closing of the door of the toilet room (step S148), and whether door sensor 81 has detected opening and closing of the entrance door (step S164). When it is determined that none of the opening and closing is detected. control section 31 determines whether it has been determined in step S172 described later that the monitoring target person has been at home (step S176). When it is determined that it has been determined that the monitoring target person has been at home, in a case where any of sensors 40 has reacted. control section 31 transmits detection data thereof to management server 20 (step S178), and ends the data measurement processing. On the other hand, when it is determined that it has not been determined that the monitoring target person has been at home, control section 31 ends the data measurement processing.

When it is determined in step S100 that the opening and closing of the door of the LDK room has been detected, control section 31 determines whether it has been determined in step S106 described later that the monitoring target person has been present in the LDK room (step S102). When it is determined that it has not been determined that the monitoring target person has been present in the LDK room, control section 31 determines whether any sensor (human sensors 42a, 42b, and 42c, door sensor 43, or temperature sensor 44) in the LDK room has reacted within a predetermined time after the opening and closing of the door of the LDK room has been detected (step S104). When it is determined that any sensor in the LDK room has not reacted within the predetermined time, control section 31 proceeds to step S176. On the other hand, when it is determined that any sensor in the LDK room has reacted within the predetermined time, control section 31 determines that the monitoring target person has entered the LDK room and is present in the LDK room, and transmits the determination result and detection data of each sensor (human sensors 42a, 42b, or 42c, door sensor 43, or temperature sensor 44) in the LDK room to management server 20 (step S106), and control section 31 controls power supply section 35 such that modes of the sensors in the rooms other than the LDK room (the sensors other than door sensors 41 and 43, human sensors 42a to 42c, and temperature sensor 44 in the LDK room) are switched to the sleep mode (step S108), and proceeds to step S176. In the present embodiment, human sensors 42a, 42b, and 42c are installed in the living section, the dining section, and the kitchen, respectively, and control section 31 determines that the monitoring target person is in the living section when human sensor 42a reacts, determines that the monitoring target person is in the dining section when human sensor 42b reacts, and determines that the monitoring target person is in the kitchen when human sensor 42c reacts. Further, in the present embodiment, door sensor 43 is provided on the door of the refrigerator, and temperature sensor 44 is provided on the front side of the refrigerator, and control section 31 determines that the monitoring target person has opened the door of the refrigerator when door sensor 43 reacts or a temperature detected by temperature sensor 44 decreases within a predetermined time by a predetermined temperature or more. One of door sensor 43 and temperature sensor 44 may be omitted.

When it is determined in step S102 that it has been determined that the monitoring target person has been present in the LDK room, control section 31 determines whether any sensor in the LDK room reacts (step S110). When it is determined that any sensor in the LDK room reacts. control section 31 determines that the monitoring target person is continuously present in the LDK room, and proceeds to step S176. On the other hand, when it is determined that any sensor in the LDK room does not react, control section 31 determines that the monitoring target person is not present in the LDK room and has left the LDK room, and transmits the determination result to management server 20 (step S112). Then, control section 31 controls power supply section 35 such that modes of all the sensors are switched to the normal mode (step S114), and proceeds to step S176.

When it is determined that the opening and closing of the door of the bedroom has been detected in step S116, control section 31 determines whether it has been determined in step S122 described later that the monitoring target person has been present in the bedroom (step S118). When control section 31 determines that it has not been determined that the monitoring target person has been present in the bedroom, control section 31 determines whether any sensor (human sensor 52 or sleep sensor 53) in the bedroom has reacted within a predetermined time after the opening and closing of the door of the bedroom has been detected (step S120). When it is determined that any sensor in the bedroom has not reacted within the predetermined time, control section 31 proceeds to step S176. On the other hand, when it is determined that any sensor in the bedroom has reacted within the predetermined time, control section 31 determines that the monitoring target person has entered the bedroom and is present in the bedroom, and transmits the determination result and detection data of each sensor (human sensor 52 or sleep sensor 53) in the bedroom to management server 20 (step S122), and control section 31 controls power supply section 35 such that modes of the sensors in the rooms other than the bedroom (the sensors other than door sensor 51, human sensor 52, and sleep sensor 53 in the bedroom) are switched to the sleep mode (step S124), and proceeds to step S176.

When it is determined in step S118 that it has been determined that the monitoring target person has been present in the bedroom, control section 31 determines whether any sensor in the bedroom reacts (step S126). When it is determined that any sensor in the bedroom reacts, control section 31 determines that the monitoring target person is continuously present in the bedroom, and proceeds to step S176. On the other hand, when it is determined that any sensor in the bedroom does not react, control section 31 determines that the monitoring target person is not present in the bedroom and has left the bedroom, and transmits the determination result to management server 20 (step S128). Then, control section 31 controls power supply section 35 such that the modes of all the sensors are switched to the normal mode (step S130), and proceeds to step S176.

When it is determined in step S132 that the opening and closing of the door of the bathroom has been detected, control section 31 determines whether it has been determined in step S138 described later that the monitoring target person has been present in the bathroom (step S134). When it is determined that it has not been determined that the monitoring target person has been present in the bathroom, control section 31 determines whether human sensor 62 in the bathroom has reacted within a predetermined time after the opening and closing of the door of the bathroom has been detected (step S136). When it is determined that human sensor 62 in the bathroom does not react within a predetermined time, control section 31 proceeds to step S176. On the other hand, when it is determined that human sensor 62 in the bathroom has reacted within the predetermined time, control section 31 determines that the monitoring target person has entered the bathroom and is present in the bathroom (taking a bath), and transmits the determination result and detection data of human sensor 62 to management server 20 (step S138), and control section 31 controls power supply section 35 such that modes of the sensors in the rooms other than the bathroom (the sensors other than door sensor 61 and human sensor 62 in the bathroom) are switched to the sleep mode (step S140), and proceeds to step S176.

When it is determined in step S134 that it has been determined that the monitoring target person has been present in the bathroom, control section 31 determines whether human sensor 62 in the bathroom reacts (step S142). When it is determined that human sensor 62 in the bathroom reacts. control section 31 determines that the monitoring target person is continuously present in the bathroom, and proceeds to step S176. On the other hand, when it is determined that human sensor 62 in the bathroom does not react, control section 31 determines that the monitoring target person is not present in the bathroom and has left the bathroom, and transmits the determination result to management server 20 (step S144). Then, control section 31 controls power supply section 35 such that the modes of all the sensors are switched to the normal mode (step S146), and proceeds to step S176.

When it is determined in step S148 that the opening and closing of the door of the toilet room has been detected, control section 31 determines whether it has been determined in step S154 described later that the monitoring target person has been present in the toilet room (step S150). When it is determined that the monitoring target person is not present in the toilet room, control section 31 determines whether any sensor (human sensor 72 or toilet faucet sensor 73) in the toilet room has reacted within a predetermined time after the opening and closing of the door of the toilet room has been detected (step S152). When it is determined that any sensor in the toilet room has not reacted within the predetermined time, control section 31 proceeds to step S176. On the other hand, when it is determined that any sensor in the toilet room has reacted within the predetermined time, control section 31 determines that the monitoring target person has entered the toilet room and is present in the toilet room, and transmits the determination result and detection data of each sensor (human sensor 72 or toilet faucet sensor 73) in the toilet room to management server 20 (step S154), and control section 31 controls power supply section 35 such that modes of the sensors in the rooms other than the toilet room (the sensors other than door sensor 71, human sensor 72, and toilet faucet sensor 73 in the toilet room) are switched to the sleep mode (step S156), and proceeds to step S176.

When it is determined in step S150 that it has been determined that the monitoring target person has been present in the toilet room, control section 31 determines whether any sensor in the toilet room reacts (step S158). When it is determined that any sensor in the toilet room has reacted. control section 31 determines that the monitoring target person is continuously present in the toilet room, and proceeds to step S176. On the other hand, when it is determined that any sensor in the toilet room has not reacted, control section 31 determines that the monitoring target person is not present in the toilet room and has left the toilet room, and transmits the determination result to management server 20 (step S160). Then, control section 31 controls power supply section 35 such that the modes of all the sensors are switched to the normal mode (step S162), and proceeds to step S176.

When it is determined in step S164 that the opening and closing of the entrance door has been detected, control section 31 determines whether it has been determined in step S168 described later that the monitoring target person has been out (step S166). When control section 31 determines that it has not been determined that the monitoring target person has been out, control section 31 determines that the monitoring target person is out (step S168). Then, control section 31 controls power supply section 35 such that the modes of all the sensors other than door sensor 81 of the entrance door are switched to the sleep mode (step S170), and proceeds to step S176.

When it is determined in step S166 that it has been determined that the monitoring target person has been out, control section 31 determines that the monitoring target person is at home because the monitoring target person has returned home from being out, and transmits the determination result to management server 20 (step S172). Then, control section 31 controls power supply section 35 such that the modes of all the sensors are switched to the normal mode (step S174), and proceeds to step S176.

In this manner, control section 31 determines in which room the monitoring target person is present, based on a combination of a door sensor that detects opening and closing of a door partitioning each room, a human sensor that detects whether a person (monitoring target person) is present in the corresponding room, and the like, and thus it is possible to more reliably specify a place where the monitoring target person is present. In addition, when it is determined that the monitoring target person is present in a certain room, control section 31 switches modes of sensors installed in the other rooms to the sleep mode, and thus it is possible to suppress unnecessary power consumption and aim energy saving as the entire system. Further, when it is determined that a door of a room in which the monitoring target person is present is opened and closed and the monitoring target person exits, control section 31 causes the modes of all the sensors to return to the normal mode, and thus it is possible to appropriately detect a destination of the monitoring target person.

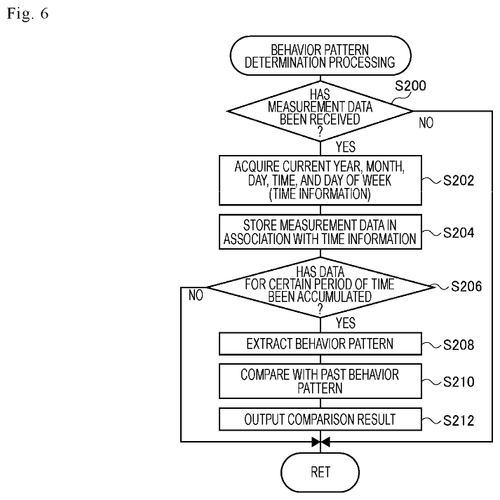

Hereinafter, an operation of management server 20 will be described. FIG. 6 is a flowchart illustrating an example of behavior pattern determination processing executed by processing section 21 of management server 20. This processing is repeatedly executed at a predetermined time interval.

In the behavior pattern determination processing. processing section 21 first determines whether measurement data (a determination result of entry and exit of the monitoring target person, the detection data from sensors 40, or the like) has been received from each monitoring apparatus 30 (step S200). When it is determined that the measurement data has not been received, processing section 21 ends the behavior pattern determination processing. On the other hand, when it is determined that the measurement data has been received, processing section 21 accesses a time server via the Internet to acquire the current year, month, day, time (hour/minute/second), and day of the week as time information (step S202), and stores the acquired time information in storage section 23 in association with the measurement data (step S204).

Next, processing section 21 determines whether data for a certain period of time (for example, for one day or for one week) has been accumulated in storage section 23 (step S206). When it is determined that the data for the certain period of time has not been accumulated yet, processing section 21 ends the behavior pattern determination processing. On the other hand, when it is determined that data for the certain period of time has been accumulated in storage section 23, processing section 21 extracts a behavior pattern from the accumulated data (step S208). The extraction of the behavior pattern is performed by determining wake-up time, meal time, the number of times visiting the toilet, bathing time, sleeping time, and the like based on the time information associated with the measurement data. The wake-up time can be determined by acquiring detection time when a change from a sleeping state to a woken state is detected by sleep sensor 53. The meal time can be determined by acquiring the occurrence time when movement from the kitchen to the dining section, the opening and closing of the refrigerator, stay in the dining section for a predetermined time or more. or the like occurs. The number of times visiting the toilet can be determined by counting the number of times of detection when toilet faucet sensor 63 detects the flush operation. The bathing time can be determined by acquiring time when entry into the bathroom is determined and time when exit from the bathroom is determined, based on a difference therebetween. The sleeping time can be determined by acquiring detection time when a change from the woken state to the sleeping state is detected by sleep sensor 53.

When the behavior pattern is extracted in this manner, processing section 21 compares the extracted behavior pattern with a behavior pattern extracted in the past (step S210). The comparison of the behavior patterns is performed by comparing, for example, each of the wake-up time, the meal time, the number of times visiting the toilet, the bathing time, and the sleeping time. Then, processing section 21 outputs a comparison result to corresponding monitoring apparatus 30 (step S212), and ends the behavior pattern determination processing. Monitoring apparatus 30 outputs the received comparison result to display section 33 and speaker 34. Accordingly, since the caregiver can obtain the behavior of the monitoring target person without being resident, it is possible to find out an abnormality of the monitoring target person at an early stage. Processing section 21 may transmit the comparison result to a portable information terminal such as a smartphone registered in advance in order to notify the monitoring target person or a protector for the monitoring target person of the comparison result.

Here, a correspondence relationship between main elements of the embodiment and main elements of the present disclosure will be described. That is, door sensors 41, 51, 61, 71, and 81 of the present embodiment correspond to opening/closing detection sensors of the present disclosure, human sensors 42a, 42b, 42c, 52, 62, and 72, door sensor 43, temperature sensor 44, sleep sensor 53, toilet faucet sensor 73, and the like correspond to human detection sensors, control section 31 that executes the processing of step S100 to S106, step S110 and S112, step S116 to S122, step S126 and S128, step S132 to S138, step S142 and S144, step S148 to S154, step S158 and S160, step S164 to S168, and step S172 of the data measurement processing corresponds to a determination section. and control section 31 that executes the processing of step S108, S114, S124, S130, S140, S146, S156, S170, and S174 of the data measurement processing corresponds to a power control section. Storage section 23 of management server 20 corresponds to a storage section, and processing section 21 that executes the behavior pattern determination processing corresponds to a comparison section.

It is needless to say that the present disclosure is not limited to the embodiments described above, and various forms can be implemented within the technical scope of the present disclosure.

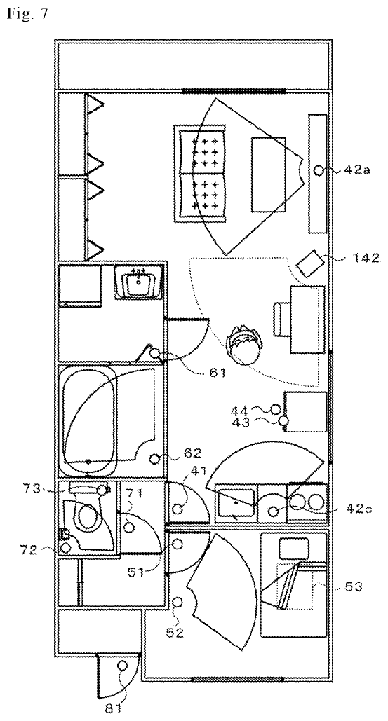

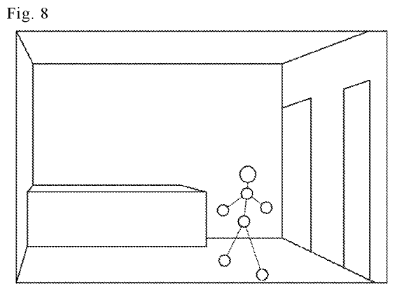

For example, in the above-described embodiment, control section 31 determines in which room the monitoring target person is present based on the combination of door sensors 41, 51, 61, 71, and 81, human sensors 42a, 42b, 42c, 52, 62, and 72, and the like. However, control section 31 may determine where the monitoring target person is and what the monitoring target person does, using a motion capture camera. As illustrated in FIG. 7, motion capture camera 142 may be installed, for example, in place of human sensor 42b in the dining section. As illustrated in FIG. 8, motion capture camera 142 detects only motions of hands and feet, a head, and a torso, and does not acquire information related to privacy such as a face, so that it is possible to suppress the monitoring target person from feeling uncomfortable for being monitored by the camera at all times.

In the behavior monitoring system of the present disclosure described above, based on detection of opening and closing of a door of any room of the residence by a corresponding opening/closing detection sensor and detection of a human by a human detection sensor provided in the room, it is determined that a monitoring target person is present in the room. Accordingly, it is possible to more reliably specify the room in which the monitoring target person is present without using an expensive sensor as the human detection sensor. Furthermore, when the room in which the monitoring target person is present is determined, a mode of a detection section (the opening/closing detection sensor and the human detection sensor) provided in a room other than the room in which the monitoring target person is present is switched from a normal mode to a power saving mode. Accordingly, it is possible to suppress power consumption to an unnecessary sensor or the like. As a result, it is possible to provide a behavior monitoring system capable of saving power at low cost.

In the behavior monitoring system as above according to the present disclosure, the power control section may switch modes of all the detection sections to the normal mode based on detection of the opening and closing of the door of the room in which the monitoring target person is present by the corresponding opening/closing detection sensor, after switching the mode of the detection section provided in the room other than the room in which the monitoring target person is present to the power saving mode. This makes it possible to appropriately detect a next destination after the monitoring target person exits the room in which the monitoring target person is currently present.

In the behavior monitoring system of the present disclosure, the human detection sensor may include a state detection sensor configured to detect a state of an installed object installed in any room of the residence. In this case, a toilet room may be provided as the room of the residence, a toilet bowl may be provided as the installed object in the toilet room, and the state detection sensor configured to detect a state of the toilet bowl may detect an operation of a flush lever or a flush switch of the toilet bowl. A refrigerator may be provided as the installed object in the room, and the state detection sensor configured to detect a state of the refrigerator may detect opening and closing of a door of the refrigerator or a change in a temperature of the refrigerator. This makes it possible to obtain the behavior of the monitoring target person using the state detection sensor.

Furthermore, in the behavior monitoring system of the present disclosure, the opening/closing detection sensor may be also installed on the entrance door of the residence, the determination section may determine that the monitoring target person is out based on detection of opening and closing of the entrance door by the corresponding opening/closing detection sensor in a state where it is determined that the monitoring target person is present in any room of the residence, and may determine that the monitoring target person has returned based on the detection of the opening and closing of the entrance door by the corresponding opening/closing detection sensor in a state where it is determined that the monitoring target person is out, and the control section may switch a mode of the detection section other than the opening/closing detection sensor configured to detect the opening and closing of the entrance door to the power saving mode based on determination that the monitoring target person is out, and may switch modes of all the detection sections to the normal mode based on determination that the monitoring target person has returned. In this way, it is possible to determine being out of monitoring target person, and it is possible to suppress power consumption to an unnecessary sensor or the like while being out.

The behavior monitoring system of the present disclosure may further include a storage section configured to store a detection result of the detection section, and a comparison section configured to extract a behavior pattern of the monitoring target person from the stored detection result and compare a current behavior pattern with a past behavior pattern. In this way, it is possible to obtain the behavior of the monitoring target person and find out the abnormality or the like at an early stage.

In the behavior monitoring system of the present disclosure, the human detection sensor may include a camera installed in any room of the residence, and the camera may be a motion capture camera configured to detect a motion of the monitoring target person. In this way, it is possible to monitor the behavior of the monitoring target person without leaving a video of a face or the like related to privacy.

The present disclosure is not limited to a form of a behavior monitoring system, and may be a form of a power saving method in a behavior monitoring system.

### INDUSTRIAL APPLICABILITY

The present disclosure can be used in a manufacturing industry of a behavior monitoring system.

### REFERENCE SIGNS LIST

10 behavior monitoring system, 11 network, 20 management server, 21 processing section, 22 communication section, 23 storage section, 30 monitoring apparatus, 31 control section, 32 communication section, 33 display section, 34 speaker, 35 power supply section, 40 sensor, 41, 43, 51, 61, 71, 81 door sensor, 42a, 42b, 42c, 52, 62, 72 human sensor, 44 temperature sensor, 53 sleep sensor, 73 toilet faucet sensor, 142 motion capture camera

1. A behavior monitoring system for monitoring a behavior of a monitoring target person who lives in a residence, the behavior monitoring system comprising:
a detection section including an opening/closing detection sensor provided on a door partitioning each room of the residence and configured to detect opening and closing of a corresponding door, and a human detection sensor provided in each room and configured to detect presence/absence of a human;
a determination section configured to determine, based on detection of opening and closing of a door of any room of the residence by the corresponding opening/closing detection sensor and detection of a human by the human detection sensor provided in the room, that the monitoring target person is present in the room; and
a power control section configured to switch, in a case where the determination section determines a room in which the monitoring target person is present, a mode of the detection section provided in a room other than the room in which the monitoring target person is present from a normal mode to a power saving mode.

2. The behavior monitoring system according to claim 1,
wherein the power control section switches modes of all the detection sections to the normal mode based on detection of the opening and closing of the door of the room in which the monitoring target person is present by the corresponding opening/closing detection sensor, after switching the mode of the detection section provided in the room other than the room in which the monitoring target person is present to the power saving mode.

3. The behavior monitoring system according to claim 1,
wherein the human detection sensor includes a state detection sensor configured to detect a state of an installed object installed in any room of the residence.

4. The behavior monitoring system according to claim 3,
wherein a toilet room is provided as the room of the residence,
a toilet bowl is provided as the installed object in the toilet room, and
the state detection sensor configured to detect a state of the toilet bowl detects an operation of a flush lever or a flush switch of the toilet bowl.

5. The behavior monitoring system according to claim 3,
wherein a refrigerator is provided as the installed object in the room, and
the state detection sensor configured to detect a state of the refrigerator detects opening and closing of a door of the refrigerator or a change in a temperature of the refrigerator.

6. The behavior monitoring system according to claim 1,
wherein the opening/closing detection sensor is also installed on an entrance door of the residence,
the determination section determines that the monitoring target person is out based on detection of opening and closing of the entrance door by the corresponding opening/closing detection sensor in a state where it is determined that the monitoring target person is present in any room of the residence, and determines that the monitoring target person has returned based on the detection of the opening and closing of the entrance door by the corresponding opening/closing detection sensor in a state where it is determined that the monitoring target person is out, and
the control section switches a mode of the detection section other than the opening/closing detection sensor configured to detect the opening and closing of the entrance door to the power saving mode based on determination that the monitoring target person is out, and switches modes of all the detection sections to the normal mode based on determination that the monitoring target person has returned.

7. The behavior monitoring system according to claim 1, further comprising:
a storage section configured to store a detection result of the detection section; and
a comparison section configured to extract a behavior pattern of the monitoring target person from the stored detection result and compare a current behavior pattern with a past behavior pattern.

8. The behavior monitoring system according to claim 1,
wherein the human detection sensor includes a camera installed in any room of the residence, and
the camera is a motion capture camera configured to detect a motion of the monitoring target person.

9. A power saving method in a behavior monitoring system for monitoring a behavior of a monitoring target person who lives in a residence, the power saving method comprising:
providing an opening/closing detection sensor configured to detect opening and closing of a corresponding door on a door partitioning each room of the residence and providing a human detection sensor configured to detect presence/absence of a human in each room; and
determining, based on detection of opening and closing of a door of any room of the residence by the corresponding opening/closing detection sensor and detection of a human by the human detection sensor provided in the room, that the monitoring target person is present in the room and switching modes of the opening/closing detection sensor and a state detection sensor, which are provided in a room other than the room in which the monitoring target person is present, from a normal mode to a power saving mode.
